(19) United States
(12) Patent Application Publication
(10) Pub. No.: US 2018/0038478 A1
(43) Pub. Date: Feb. 8, 2018

(54) ROTATING OPERATION INPUT DEVICE, AND SHIFTING OPERATION DEVICE USING SAME

(71) Applicant: Panasonic Intellectual Property Management Co., Ltd., Osaka (JP)

(72) Inventors: TORU ARAKAWA, Fukui (JP); MASAHIRO MIZUKAMI, Fukui (JP); MASAMINE YASUI, Fukui (JP)

(21) Appl. No.: 15/724,302

(22) Filed: Oct. 4, 2017

Related U.S. Application Data
(63) Continuation of application No. PCT/JP2016/002833, filed on Jun. 13, 2016.

(30) Foreign Application Priority Data
Aug. 4, 2015 (JP) 2015-153877

(51) Int. Cl. F16H 61/24; F16H 59/08

(52) U.S. Cl. CPC F16H 61/24; F16H 59/08; F16H 2059/0221

(57) ABSTRACT

The rotating operation input device has the structure in which the click section applies a clicking force to the shaft at a predetermined rotation angle, and the first controller controls the actuator, based on the control signal received from the second controller, so as to apply a desired external force to the shaft. A shifting operation device is structured by connecting the rotating operation input device to the second controller for controlling the shifting device.

### CROSS-REFERENCE TO RELATED APPLICATIONS

This application is a continuation of the PCT International Application No. PCT/JP2016/002833 filed on Jun. 13, 2016, which claims the benefit of foreign priority of Japanese patent application No. 2015-153877 filed on Aug. 4, 2015, the contents all of which are incorporated herein by reference.

### BACKGROUND

### 1. Technical Field

The present disclosure relates to a rotating operation input device mainly used for shifting operation of vehicles and is disposed close to the driver's seat in the vehicle interior. The rotating operation input device outputs a predetermined switching signal to the shifting device of vehicles in response to rotating operation. The present disclosure also relates to a shifting operation device including the rotating operation input device.

### 2. Description of the Related Art

In recent years, a rotating operation input device, which is disposed close to the driver's seat in the vehicle interior for performing shifting operation by rotating operation, and a shifting operation device using the input device have been increasing. Reliability and various operations have been needed for such a device.

The shifting operation device disclosed in Japanese Unexamined Patent Application Publication No 2009-519855 is known as one of the conventional devices.

A rotating operation input device used for such a conventional shifting operation device has detecting means, an actuator and a controller. The detecting means includes an operation body fixed to a shaft for rotating operation, and detects a rotation angle of the shaft. The actuator applies an external force to the shaft. The controller controls the external force to be applied to the shaft via the actuator, and switches the shifting device of the vehicle to a predetermined shift state, in response to the rotation of the operation body.

### SUMMARY

The aim of the present disclosure is provision of a rotating operation input device in which the operation body is retained with stability at a predetermined position even when the actuator is not working, and in the rotating operation, the operation body is positioned with certainty at a desired rotating position. The aim of the present disclosure is also provision of a shifting operation device including the aforementioned rotating operation input device.

A rotating operation input device according to the present disclosure has a shaft, an operation body, a detector, an actuator, a first controller, and a click section. The operation body is fixed to the shaft so as to be rotatable on the shaft. The detector detects rotation of the shaft and outputs a detection signal. The actuator applies an external force to the shaft. The first controller outputs an angular signal according to the detection signal and controls the actuator by a control signal obtained according to the angular signal. The click section is formed of a resilient-contact section and a click cam member that is fixed to the shaft. The click cam member has an uneven section on one of an outer side and an inner side. The resilient-contact section makes a resilient contact with the uneven section of the click cam member. The click section applies a clicking force to the shaft at a predetermined rotation angle at the shaft; at the same time, the first controller controls the actuator by the control signal so that the actuator applies an external force to the shaft with a desired amount. Further, a shifting operation device according to the present disclosure has the above-mentioned rotating operation input device and a second controller for controlling a shifting device. The second controller is connected to the rotating operation input device. The first controller outputs an angular signal according to rotating operation of the operation body. In response to the angular signal, the second controller outputs the control signal to the first controller and controls a shifting device of the vehicle.

According to the present disclosure, the click section applies a clicking force to the shaft on a constant basis even when the actuator is not working, allowing the operation body to be stably retained at a predetermined position. Additionally, in the rotating operation, the shaft receives a clicking force applied by the click section in addition to the external force applied by the actuator; thereby the operation body can be easily located with reliability at a desired rotating position. The aforementioned structure offers advantageous effects, that is, it provides the rotating operation input device and the shifting operation device including the rotating operation input device with a good feel of operation and various operations.

### BRIEF DESCRIPTION OF DRAWINGS

FIG. 1 is a configuration diagram of a rotating operation input device and a shifting operation device in accordance with an exemplary embodiment of the present disclosure.

FIG. 2 is an exploded perspective view of the rotating operation input device shown in FIG. 1.

FIG. 3 is an exploded perspective view showing the essential part of an actuator of the rotating operation input device shown in FIG. 2.

FIGS. 4A to 4C illustrate an operation force in operation of the rotating operation input device in accordance with the exemplary embodiment of the present disclosure.

FIG. 5 is a plan view of an example of an apparatus that employs the rotating operation input device shown in FIG. 1.

### DETAILED DESCRIPTION OF PREFERRED EMBODIMENTS

Prior to describing an exemplary embodiment of the present disclosure, a problem of the conventional device will be described briefly.

In the conventional rotating operation input device described above, for example, when the ignition key is in the OFF state, the actuator is not working and therefore the shaft has no application of an external force from the actuator. This causes an unstable state of the operation body and has difficulty in retaining the operation body at a desired position with stability. Besides, in rotating operations, it is difficult to stop the operation body at a predetermined position with certainty.

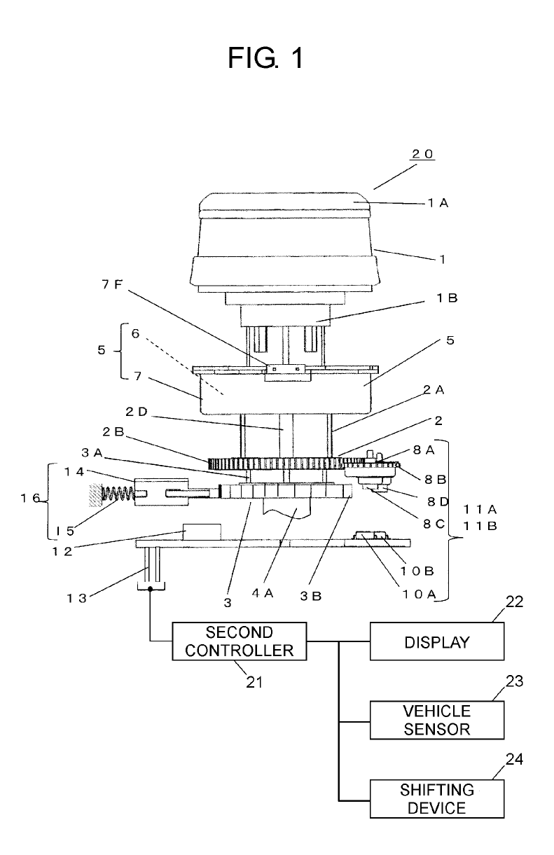

Hereinafter, an exemplary embodiment of the present disclosure will be described with reference to FIG. 1 through FIG. 3.

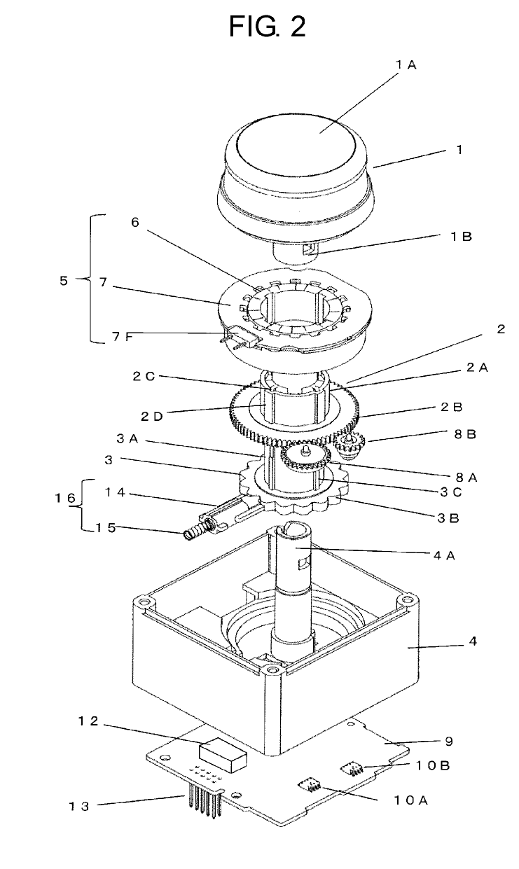

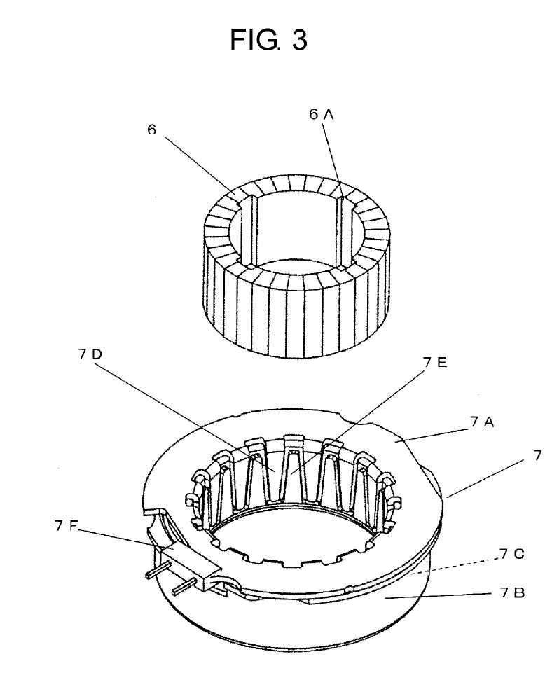

FIG. 1 is a configuration diagram of rotating operation input device 20 and a shifting operation device in accordance with an exemplary embodiment of the present disclosure. FIG. 2 is an exploded perspective view of rotating operation input device 20. FIG. 3 is an exploded perspective view showing actuator 5 of rotating operation input device 20. Rotating operation input device 20 includes operation body 1, first detector 11A, second detector 11B, actuator 5, first controller 12, and click cam member 3 and resilient-contact section 16 which serve as a click section.

Operation body 1 is made of synthetic resin and has operating section 1A formed substantially into a circular cylinder in the upper section and joint section 1B in the lower section integrally formed as one structure with operation body 1.

Rotating body 2 is made of synthetic resin and has shaft 2A formed substantially into a hollow cylinder in the upper section on the side close to operation body 1, and rotary gear 2B formed on the circumference of the lower section.

Click cam member 3 is made of synthetic resin and has shaft 3A formed substantially into a hollow cylinder in the upper section, and click cam 3B in the lower section integrally formed as one structure with shaft 3A. Click cam 3B has a plurality of crest (convex) parts and valley (concave) parts alternately disposed in an annular arrangement on the circumference of the lower section.

Case 4 is formed substantially into a box, and has fixed shaft 4A that is substantially formed into a circular cylinder and protrudes upwardly from the bottom of case 4.

The inner circumference (not shown) of shaft 3A and joint section 1B of operation body 1 are fixed to each other in the rotating direction. Thus, operation body 1 is rotatably fixed to click cam member 3. Shaft 3A has a plurality of locking sections 3C protruding at predetermined intervals from the outer circumference of shaft 3A and extending in the vertical direction. Shaft 2A of rotating body 2 is provided with groove-shaped engagement sections 2C formed on the inner circumference of shaft 2A. Locking sections 3C engage with groove-shaped engagement sections 2C, so that click cam member 3 is fixed to rotating body 2 in the rotating direction.

Operation body 1, rotating body 2, and click cam member 3 are thus rotatably fixed to each other, and are rotatably supported by fixed shaft 4A.

As shown in FIG. 3, actuator 5 has coil member 7 on its outer side and magnet member 6 formed into a substantially ring. Magnet member 6 is rotatably disposed in the hollow section on the inner side of coil member 7.

Magnet member 6 of an integrated ring-shape is formed of a plurality of vertically extending magnets. Theses magnets are disposed such that N-poles and S-poles of the magnets are alternately arranged in a circular manner.

Coil member 7 has upper cover 7A, lower cover 7B, and coil section 7C having wound coil wire (for example, copper wire). Upper cover 7A and lower cover 7B are made of iron, for example, soft iron. Coil section 7C is accommodated in the substantially ring-shaped space between upper cover 7A and lower cover 7B.

On the inner circumference of upper cover 7A, a plurality of upper protrusions 7D are provided. Each of upper protrusions 7D is formed into a substantially triangle and protrudes downward. On the inner circumference of lower cover 7B, a plurality of lower protrusions 7E are provided. Each of lower protrusions 7E is formed into a substantially triangle and protrudes upward. Upper protrusions 7D and lower protrusions 7E are alternately disposed, with predetermined gaps, on the entire area of a same inner circumference.

Both ends of coil section 7C are connected to power-supply input section 7F disposed at a position of the outer circumference of upper cover 7A.

When electric power controlled by first controller 12 (that will be described later) is externally supplied to coil section 7C via power-supply input section 7F, the upper protrusions and the lower protrusions are magnetized to a predetermined magnetic pole (N-pole or S-pole) by coil section 7C, thereby an attraction force and a repulsion force are generated between the magnetic poles of the magnetized protrusions and the alternately arranged magnetic poles of magnet member 6. These forces are exerted onto magnet member 6 as an external force.

Further, on the inner circumference of magnet member 6, a plurality of engagement sections 6A each formed into a substantially groove is disposed so as to extend in the vertical direction of magnet member 6. On the outer circumference of shaft 2A of rotating body 2, a plurality of vertically extended locking sections 2D is provided at predetermined intervals so as to protrude from the outer circumference of shaft 2A. Engaging locking sections 2D with respective engagement sections 6A allows magnet member 6 to be rotatably fixed to rotating body 2.

As described above, operation body 1 and click cam member 3 are rotatably fixed to each other; rotating body 2 and click cam member 3 are rotatably fixed to each other; and rotating body 2 and magnet member 6 are rotatably fixed to each other. Therefore, operation body 1, rotating body 2, click cam member 3, and magnet member 6 are united to form a united structure. Inserting fixed shaft 4A through shafts 2A and 3A allows the united structure to be rotatable on fixed shaft 4A, i.e., rotatable on the shaft center of shafts 2A and 3A.

First detection gear 8A and second detection gear 8B mesh with the outer circumference of rotary gear 2B of rotating body 2, and thus are rotatably supported (not shown), coordinating with the rotation of rotating body 2. First magnet 8C is fixed to the lower surface of first detection gear 8A and, second magnet 8D is fixed to the lower surface of second detection gear 8B.

Among these gears, rotary gear 2B is the greatest in diameter and in the number of teeth, first detection gear 8A comes next, then second detection gear 8B follows in the term of the diameter and the number of teeth.

On the upper surface of wiring board 9, such as a printed-wiring board, first detection element 10A and second detection element 10B are disposed. First detection element 10A faces first magnet 8C disposed above via a predetermined distance. Similarly, second detection element 10B faces second magnet 8D disposed above. First detection element 10A and second detection element 10B are magnetism detection elements, for example, AMR (anisotropic magneto-resistance) elements.

First magnet 8C disposed on the lower surface of first detection gear 8A and first detection element 10A, which faces first magnet 8C form first detector 11A. Similarly, second magnet 8D disposed on the lower surface of second detection gear 8B and second detection element 10B, which faces second magnet 8D form second detector 11B.

Further, on the upper surface of wiring board 9, first controller 12 is mounted and input/output section 13 is disposed. First controller 12 is formed of a microcomputer, for example; and input/output section 13 is formed of a plurality of terminal sections connected to a wiring pattern.

When rotating body 2 rotates, first detection gear 8A and second detection gear 8B are rotated via rotary gear 2B. As a result, first detector 11A and second detector 11B output respective detection signals to first controller 12. Receiving the detection signals, first controller 12 calculates an absolute rotation angle of rotating body 2, i.e., operation body 1, and outputs an angular signal corresponding to the absolute rotation angle. Note that the absolute rotation angle represents a rotating direction and a total rotation angle with respect to a predetermined reference position. For example, when operation body 1 rotates one revolution clockwise with respect to the predetermined reference position, the absolute rotation angle is calculated as +360 degrees. When operation body 1 rotates two revolutions, the absolute rotation angle is +720 degrees; two and a half revolutions correspond to 900 degrees, and three revolutions correspond to 1080 degrees. In contrast, when operation body 1 rotates one revolution counterclockwise, the absolute rotation angle is calculated as −360 degrees.

Click cam 3B, which is disposed on the outer circumference of click cam member 3, has crest parts whose tips outwardly protrude into a mountain shape or a spherical shape and valley parts curved toward the inside. The crest parts and the valley parts are alternately formed at predetermined intervals. Click pin 14 and coil spring 15 are disposed in case 4. Click pin 14 is formed into a substantially circular cylinder as the entire structure. Coil spring 15 makes the tip section of click pin 14 resiliently contact with click cam 3B.

The tip section of click pin 14 makes resilient contact with click cam 3B by urging of coil spring 15. Click pin 14 and coil spring 15 form resilient-contact section 16. Further, resilient-contact section 16 and click cam 3B form a click section.

Wiring board 9 is disposed so as to cover the bottom surface of case 4. Rotating operation input device 20 is thus structured.

Such structured rotating operation input device 20 is disposed in the front section of the vehicle interior, for example, on a dashboard or a center console. First controller 12 is connected to second controller 21 of the vehicle via input/output section 13 as shown in FIG. 1. Second controller 21 is connected to shifting device 24 for changing the shift range so as to form the shifting operation device. Further, display 22 such as an LCD device, and vehicle sensor 23 are connected to second controller 21. Vehicle sensor 23 detects various conditions of a vehicle, for example, a speed, and a rudder angle of the steering wheel.

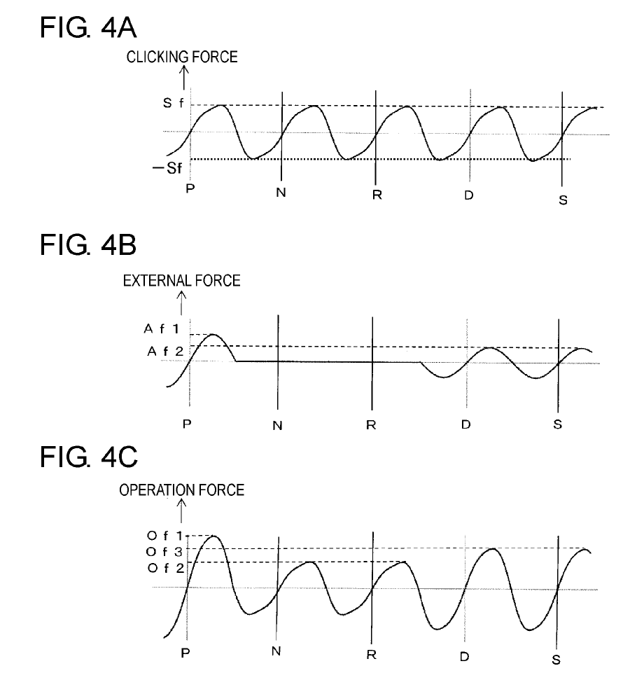

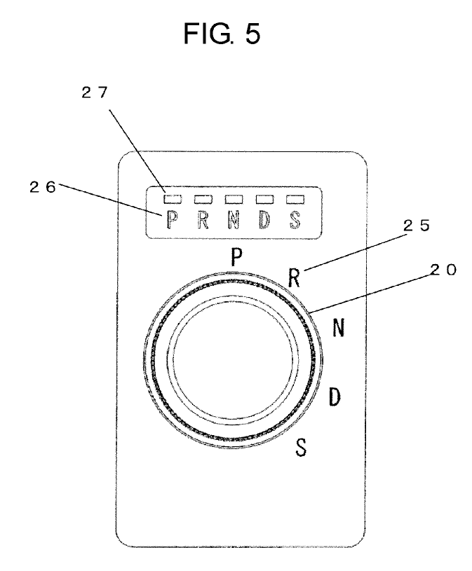

Next, the workings of rotating operation input device 20 and the shifting operation device with the aforementioned structure will be described with reference to FIGS. 4A to 4C and FIG. 5. FIGS. 4A to 4C illustrate operation forces generated in the device, and FIG. 5 is a plan view of an apparatus in which rotating operation input device 20 is mounted.

As shown in FIG. 5, on the panel in which rotating operation input device 20 is disposed, letters 25 of ‘P’, ‘R’, ‘N’, ‘D’, and ‘S’ are shown clockwise at a predetermined angular interval in the proximity of the outer circumference of operation body 1. Similarly, letters 26 of ‘P’, ‘R’, ‘N’, ‘D’, and ‘S’ are shown, too, from left to right in a place above rotating operation input device 20. Besides, indicators 27 are disposed just above respective letters 26 to illuminate letters 26 by light-emitting device from the inner side of the panel.

As for the letters above, ‘P’ represents the P (parking) range; ‘R’ represents the R (reverse) range; ‘N’ represents N (neutral) range; ‘D’ represents the D (drive) range; and ‘S’ represents the S (sport) range.

FIG. 4A shows changes in clicking force in response to clockwise rotating operation of operation body 1 from the P-range the S-range by the click section. FIG. 4B shows changes in external force applied by actuator 5 in the rotating operation the same with in FIG. 4A. FIG. 4C shows changes in operation force actually applied to operation body 1 as a composed force of the clicking force shown in FIG. 4A and the external force shown in FIG. 4B.

When the ignition key is in the OFF state, actuator 5 has no power supply. In the state, the tip section of click pin 14 is located in a valley part of click cam 3B with a resilient contact. At that time, as shown in FIG. 4A, the tip section of click pin 14 is retained with respect to the rotation in the left-to-right direction at the position of the P range by only the clicking force, and external force by actuator 5 is not applied to the tip section of click pin 14 as shown in FIG. 4B.

Next, when operating section 1A is rotated clockwise from the P-range position, the clicking section applies a clicking force to operation body 1 according to the shape of the cam crest of click cam 3B. For example, the clicking section produces a clicking force with an amplitude having maximum resisting force +Sf and maximum attraction force −Sf. Thereafter, click cam 3B is rotated further to the N-range position, then the tip section of click pin 14 is retained. When operating section 1A is further rotated clockwise, the clicking section produces the clicking force with an amplitude having maximum resisting force +Sf and maximum attraction force −Sf as peaks at each time when operating section 1A is rotated to the next position from the N-range to the S-range, and a retaining force is produced at each position.

Specifically, it is preferable click cam 3B is structured such that the cam crests are arranged on a circumference at a predetermined angular interval with a fixed distance away from the shaft center of click cam 3B. Click cam member 3 is preferably formed so as apply a constant clicking force to shaft 3A with for a constant rotation angle of click cam 3B

In a first state, operation body 1 is retained with a resilient contact at one of the valley parts of click cam 3B. When the ignition key is operated to put into the ON state from the OFF state, first controller 12 receives detection signals from first detector 11A and second detector 11B and detects the rotation angle of rotating body 2, i.e., operation body 1 based on the detection signals, in the first state. At that time, first controller 12 outputs, to second controller 21, an angular signal that represents an absolute rotation angle of operation body 1. Second controller 21 determines that the first state is the P-range state, and illuminates the light-emitting device which is disposed at a position above ‘P’ of letters 26 inside indicator 27. Thus, the driver can visually recognize that the shift range is in the P-range. At the same time, second controller 21 outputs a predetermined switching signal to shifting device 24, thereby shifting device 24 is put into the P-range state.

Further, at that time, second controller 21 outputs a predetermined control signal to first controller 12. In response to the control signal, first controller 12 supplies, via power-supply input section 7F, coil section 7C with electric power of a predetermined amount so as to be suitable for the P-range. As a result, as shown in FIG. 4B, according to a rotation angle in the rotating direction from the P-range toward the N-range, a desired external force with maximum Af is applied to shaft 2A via magnet member 6.

That is, when operation body 1 is rotated from the P-range to the N-range, external force Af1 by actuator 5 is applied to operation body 1 in addition to clicking force Sf by the clicking section. As shown in FIG. 4C, operation body 1 undergoes operation force Of1. That is, the force to be applied to operation body 1 is increased so as to suppress operation body 1 from being operated too easily.

Similarly, when operation body 1 is rotated clockwise, as shown in FIG. 4C, from the substantial middle of the P-range and the N-range to the R-range via the N-range, clicking force Sf shown in FIG. 4A is only applied as operation force Of2 to operation body 1. When operation body 1 is further rotated from the R-range to the D-range and the S-range, second controller 21 outputs a predetermined control signal in response to a received angular signal; at the same time, in a position between the R-range and D-range, first controller 12 makes actuator 5 apply predetermined external force Aft slightly smaller than external force Af1, for example, onto shaft 2A, so that operation body 1 undergoes operation force Of3.

As described above, the clicking section applies a clicking force to operation body 1 at a predetermined rotation angle. At the same rotation angle, receiving an angular signal corresponding to the rotating operation of operation body 1, second controller 21 makes actuator 5 apply a desired external force suitable for the angular signal to operation body 1. Therefore, rotating operation input device 20 can be set for various operation forces with magnitude of an external force, an angular range for the application of the force, and a gradient of the external force to be generated. Accordingly, rotating operation input device 20 is applicable to various types of vehicles, such as an RV (recreational vehicle), a family-use vehicle, and a luxury sedan, with no difference in the basic structure of the device.

Meanwhile, first controller 12 of rotating operation input device 20 may output an angular signal corresponding to an absolute rotation angle of operation body 1 to second controller 21, thereby actuator 5 can be controlled so as to apply a desired external force with higher accuracy to operation body 1. Further, compared to the structure where the rotation angle and the position of the operation body are detected by calculation of a detection signal directly fed from, for example, a photo detector and a magnetic sensor, second controller 21 on the vehicle-side does not need controlling based on complicated calculations so that second controller 21 can have a simplified control architecture.

As for click cam 3B having the crest parts and valley parts that form the clicking section, the number of the cam crest, the width size, and the center position have fixed values for each shape in advance. Therefore, the rotation angle of operation body 1 can be estimated from the values. In the method, however, the rotation angle, since it is obtained with no direct measurement, may have a margin of error. Further, the margin of error can increase with time due to wear of the crest parts and valley parts and the resilient-contact section (the tip section of click pin 14) by repeatedly using rotating operation input device 20. In contrast, according to the structure of the embodiment, first detector 11A and second detector 11B offer non-contact detection of an absolute rotation angle of operation body 1. That is, from not only theoretical but also at a view of temporal change, highly accurate detection of rotation angle can be obtained.

When the vehicle is at a stop, vehicle sensor 23 detects that the vehicle is in the stopped state and outputs a predetermined detection signal to second controller 21. Further, when the ignition key is switched to the OFF state while rotating operation input device 20 is located at any one of the shift ranges, second controller 21 detects that the ignition key is in the OFF state. At the same time, in response to the signal from vehicle sensor 23 that indicates the stopped state of the vehicle, second controller 21 outputs a switching signal to shifting device 24 so as to switch the range to the P-range, thereby shifting device 24 is switched to the P-range. The structure eliminates the need for switching rotating operation input device 20 to the position of the P-range each time the ignition key is put into the OFF state, enhancing user-friendliness of shifting operation.

As described above, rotating operation input device 20 according to the present embodiment has operation body 1, first detector 11A and second detector 11B, actuator 5, first controller 12, and a click section. Operation body 1 is fixed to shaft 2A so as to be rotatable on shaft 2A. First detector 11A and second detector 11B detect a rotation angle of shaft 3A and output detection signals, respectively. Actuator 5 applies an external force to shaft 2A. First controller 12 outputs an angular signal according to the detection signals and control actuator 5 by a control signal received from second controller 21. The control signal is determined based on the angular signal. The click section includes click cam member 3 and resilient-contact section 16. Click cam member 3 is fixed to shaft 3A and has an uneven section on the outer side or on the inner side. Resilient-contact section 16 makes a resilient contact with the uneven section of click cam member 3. The click section applies a clicking force suitable for a predetermined rotation angle to shaft 3A. At the same rotation angle, first controller 12 controls actuator 5 by the control signal received from second controller 21 so as to apply a desired external force to the shaft. A shifting operation device can be formed by connecting rotating operation input device 20 thus structured to second controller 21 for controlling shifting device 24. According to rotating operation input device 20 and the shifting operation device thus structured, operation body 1 is stably retained at a predetermined position even when actuator 5 is not working In the rotating operation, operation body 1 can be easily located with reliability at a desired rotating position.

The description above introduces a structure where first controller 12 is disposed in rotating operation input device 20 while second controller 21 is disposed on the vehicle side. However. the rotating operation input device may have first and the second controllers connected to each other, and the second controller may be connected to the display, the vehicle sensor, and the shifting device disposed on the vehicle side.

Further, second controller 21 may be connected to vehicle sensor 23 that detects vehicle conditions, such as a speed, and a rudder angle of the steering wheel. In this case, second controller 21 can control shifting device 24 based on a predetermined sensing signal indicating the vehicle conditions fed from vehicle sensor 23 and an angular signal fed from first controller 12. The structure above enhances user-friendliness in the shifting operation. For example, suppose that operation body 1 is located at a position other than the P-range when the vehicle is stopped. Even in that case, when the ignition key is put into the OFF state, rotating operation input device 20 switches shifting device 24 to the P-range.

Further, rotating operation input device 20 may have first controller 12 only, without second controller 21. In that case, first controller 12 outputs an angular signal according to a detection signal, and generates a predetermined control signal according to the angular signal, which controls actuator 5. The structure above allows rotating operation input device 20 to cover the control on actuator 5, eliminating external control on actuator 5.

The rotating operation input device and the shifting operation device equipped with the rotating operation input device of the present disclosure allow the operation body to be stably retained at a predetermined position even when the actuator is not working, and also allow the operation body to be easily located with reliability at a desired position in the rotating operation. The structure having such an advantageous effect is especially useful for the shifting operation of vehicles.

What is claimed is:

1. A rotating operation input device comprising:
an operation body fixed to a shaft so as to be rotatable on the shaft;
a detector that detects rotation of the shaft and outputs a detection signal;
an actuator that applies an external force to the shaft;
a first controller that outputs an angular signal according to the detection signal and controls the actuator by a control signal obtained according to the angular signal; and
a click section formed of a click cam that is fixed to the shaft and has an uneven section on one of an outer side and an inner side, and a resilient-contact section that makes a resilient contact with the uneven section of the click cam,
wherein at a predetermined rotation angle of the shaft, the click section applies a clicking force to the shaft and the first controller controls the actuator with the control signal so that the click section applies the external force to the shaft with a desired amount.

2. A shifting operation device comprising:
the rotating operation input device defined in claim 1; and
a second controller disposed on a vehicle and connected to the rotating operation input device,
wherein the angular signal is outputted to the second controller at a time of rotating operation of the operation body, and according to the angular signal, the second controller outputs the control signal to the first controller and controls a shifting device of the vehicle.

3. The sifting operation device according to claim 2,
wherein the rotating operation input device has the first controller and the second controller therein.

4. The shifting operation device according to claim 3,
wherein the second controller is connected to a vehicle sensor, and the second controller controls the shifting device according to a sensing signal from the vehicle sensor and the detection signal.

5. The shifting operation device according to claim 2,
wherein the second controller is connected to a vehicle sensor, and the second controller controls the shifting device according to a sensing signal from the vehicle sensor and the detection signal.
